(19) United States
(12) Patent Application Publication
(10) Pub. No.: US 2005/0094216 A1
(43) Pub. Date: May 5, 2005

(54) Portable flatbed scanner

(76) Inventor: Hengning Wu, Reston, VA (US)

Correspondence Address: HENGNING WU, 11627 NORTH SHORE DR. 2B, RESTON, VA, 20190, US

(21) Appl. No.: 10/605,692

(22) Filed: Oct. 17, 2003

(51) Int. Cl. H04N 1/04; H04N 1/047; H04N 1/10

(52) U.S. Cl. 358/474; 358/497; 358/488

(57) ABSTRACT

A portable flatbed scanner with one transparent platen facing the original document and another transparent platen at the back of the housing for the scanning mechanism. The original document is placed face up, but the portable flatbed scanner is placed face down on the original document, and the user can see the original document through the two transparent platens. Therefore, the effect of “what you see is what you scan” is achieved. As a result, the scanning area can be set without a prescan and the portable flatbed scanner can be used as a standalone scanner. Bibliographic information can be associated with a scanned image.

### BACKGROUND OF INVENTION

The present invention generally relates to a digital image scanner and specifically to a portable flatbed scanner.

Existing digital image scanners are generally handheld, sheet-fed or flatbed. Handheld scanners slide or roll across the original document in strips, typically about 4 inches wide, and digital images are reintegrated from the scanned data using stitching software. The image quality from a handheld scanner is not high due to its dependence on the smoothness and alignment of the rolling operation. Sheet-fed scanners are generally integrated into another machine, such as a fax machine. Flatbed scanners provide a housing for the scanning mechanism. The original document is placed face down on a transparent glass platen and the scanning mechanism beneath the glass platen moves across the document in a carriage and scans the original document. Owing to their high resolution and versatile uses, flatbed scanners become the dominant digital image scanner on the market today.

A typical flatbed scanner provides a scanning area accommodating the letter size paper and the A4 size paper. The most common uses of a flatbed scanner are scanning of photographs and text documents into digital images. The text document images can be further processed by an optical character recognition (OCR) program into digital text files. Previous improvements on flatbed scanners are related to reduction in size and addition of more functions. Examples include U.S. Pat. No. 6,204,494 by Chavez, U.S. Pat. No. 6,608,707 by Han, U.S. Pat. No. 6,389,183 by Han, U.S. patent application Ser. No. 09/732,315 by Han et al., and U.S. patent application Ser. No. 09/960,197 by Khovaylo et al.

However, several shortcomings of the flatbed scanners have not been recognized or properly addressed in the prior art. First, placing the original document face down is against the natural reading behavior and the user cannot see what he is scanning. Second, it is not possible to select directly a part of the original for scanning, and a prescan is required for selecting the desired part. Third, for notes-taking purpose, it is often desirable to identify the bibliographic source of the scanned documents, but there are no convenient way to do this in the prior art.

Many people, such as students, professors, researchers, and writers, use a digital scanner for notes-taking purpose. Fourth, most flatbed scanners are not portable. The preferred scanning area for the letter size paper makes the flatbed scanners too big to carry around. On the other hand, simply scaling the size down to a smaller scanning area, such as 4 inch by 6 inch, limits the usefulness of the scanner. Fifth, flatbed scanners normally have to be used in association with a computer. Although operation software can be put into the flatbed scanners, such standalone flatbed scanners are not very useful without a computer screen to see the image and set the scanning area.

### SUMMARY OF INVENTION

Therefore, it is the object of the present invention to provide a portable flatbed scanner which allows the user to see what is scanned. The user can set the scanning area directly without a prescan. This will make the portable flatbed scanner an indispensable tool for taking notes.

According to one aspect of the invention, there is a transparent platen at the back of the housing for the scanning mechanism in addition to the transparent platen facing the original document. The original document is placed face up, but the scanner is placed face down on the original document, and the user can see the original document through the two transparent platens. Therefore, the effect of “what you see is what you scan” is achieved.

According to another aspect of the invention, devices are provided to set the desired scanning area. The scanning area can be easily set since the original document is viewable to the user.

According to still another aspect of the invention, a grid pattern is provided on the back platen for proper alignment of the original document with the scanner.

According to still another aspect of the invention, an index number display and means for setting the index number are provided, and associated software is used to identify the scanned image, such as the page number of the document.

According to still another aspect of the invention, CPU and related memory are provided to run the software and store the image files so that the scanner can stand alone without a computer.

### BRIEF DESCRIPTION OF DRAWINGS

FIG. 1 shows a typical prior art flatbed scanner.

FIG. 2 shows a portable flatbed scanner according to the present invention.

FIG. 3 is a top view of the portable flatbed scanner of FIG. 2.

FIG. 4 shows the portable flatbed scanner with a cover.

### DETAILED DESCRIPTION

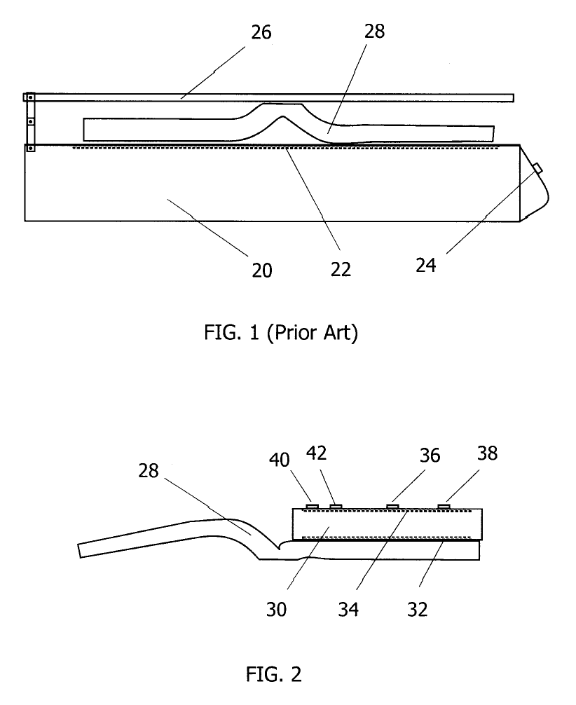

As illustrated in FIG. 1, a typical flatbed scanner 20 has a transparent glass platen 22 and function buttons 24. The transparent platen 22 defines the maximum scanning area. The original document 28 is placed face down on the transparent platen 22. A document cover 26 is closed over the document to hold the document in place and to shut out ambient light. Inside the housing of the flatbed scanner, there is a scanning mechanism to generate digital image data representing the original document. The scanning mechanism including a light source and a scanning element (either contact image sensor or charged-couple device) is generally mounted on a carriage. The carriage sits beyond the left edge of the transparent platen 22 before scanning, and moves along the transparent platen 22 to generate the digital image data. Normally a flatbed scanner is used in association with a computer through a computer interface (not shown), such as a Universal Serial Bus (USB) interface. The software in the computer can set up the scanning parameters and control the scanning operation.

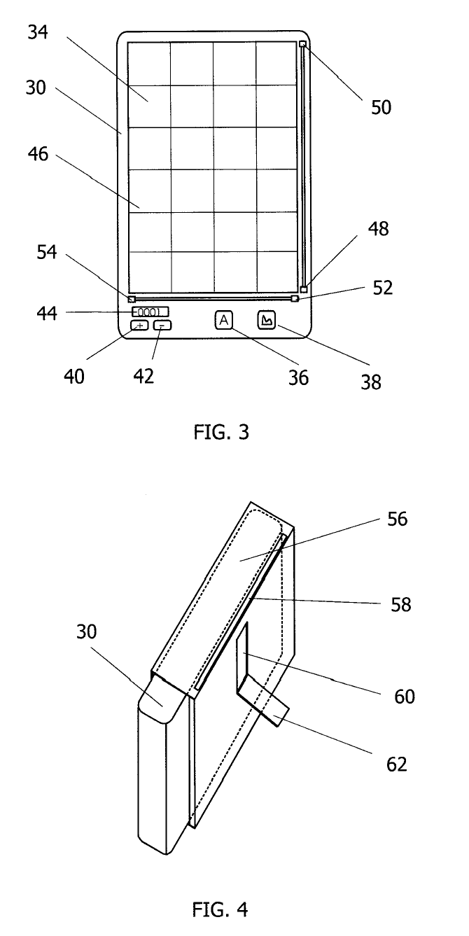

FIGS. 2 and 3 are respectively the side view and top view of the portable flatbed scanner 30 according to the present invention. As shown in FIG. 2, the original document 28 is placed face up at its natural position for reading. The portable flatbed scanner 30 has a back transparent platen 34 at the back of the housing for the scanning mechanism in addition to the front transparent platen 32 facing the original document. The scanner 30 is placed face down on the original document, and the user can see the content of the original document 28 through the two transparent platens. To reduce the size of the scanner, the scanning element is preferably a contact image sensor. The guide for the scanning mechanism carriage inside the scanner housing is preferably located at the sides of the scanner to allow an unblocked view of the original document. Tests showed that ordinary ambient light from the back transparent platen 34 would not have noticeable effects on the quality of the scanned images. In case of adverse effects from strong ambient light, a lid can be easily provided to cover the transparent platen 34 during a scanning operation.

As shown in FIG. 3, the function buttons are located at the back of the portable flatbed scanner 30. There are two buttons for starting a scan, a text scan button 36 for text documents and a picture scan button 38 for pictures. The scanning parameters for these two common tasks can be set up through a computer, and default values are provided for these parameters. For example, the scanning parameters for text documents can be: resolution 300 dots per inch, black and white, and brightness 50%. The scanning parameters for pictures can be: resolution 300 dots per inch, color scan, brightness 50%, and contrast 50%. Generally, a resolution of 300 dots per inch is needed for optical character recognition.

The index number LCD display 44 and the related buttons for increase 40 and decrease 42 are used to identify the bibliographic information of the scanned image. The initial setting of the index number is 0000. At this setting, the bibliographic information, such as the related information page in a book, can be scanned. The information can be converted into a text file, and the related information can be further edited to provide the bibliographic data for later entries. Any index number afterwards indicates that the scanned image corresponds to a certain page number. The information is saved along with the digital image files. For example, when a user takes notes from a book, the bibliographic information is only scanned once, and all the notes taken have the corresponding page numbers with them. This will be very convenient for use of the notes in quotations and research papers.

As shown in FIG. 3, the back transparent platen 34 has a grid pattern 46 on it to facilitate the alignment of the original document with the portable flatbed scanner 30. For a typical maximum scanning area of 4 inch by 6 inch, a grid spacing of 1 inch can be used. The grid pattern is preferably printed on the inside surface of the platen 34 for durability.

The scanning area can be easily set without a prescan since the original document is viewable to the user. As shown in FIG. 3, slides 48 and 50 set the scanning boundaries along the length direction, and slides 52 and 54 set the scanning boundaries along the width direction. Methods to measure distance can be adapted to measure the boundaries and then the data can be converted to control signals to operate the scanning mechanism. For example, the methods used to detect the position of a touch on a touchscreen can be adapted to determine the locations of the slides. Take the example of a resistive overlay, two linear overlay structures are created along each slidebar for the two slide positions. The overlay structure consists of conductive layers separated by a line of tiny insulating dots. Pressure from an elastic contact from the slide pushes the two layers together, creating an electrical contact. The electrical contact will give a specific voltage related to the location of the contact. The voltage signal is then converted into digital data for controlling the scanning mechanism. In fact, a sensitive screen can be used for the back transparent platen 34 and two points at diagonal position can define the scanning area. Another way is to attach each slide to a string connected to a rotating device. The rotation can produce a physical signal corresponding to the distance of sliding, for example, in a similar way as the slotted disk in a mechanical mouse for the computer. If one of the corner of platen 34 is used as the origin of the scanning area, only one slide is needed for each direction.

With the ability to select the desired scanning area from a portable flatbed scanner, a user has the freedom to take reference notes from a variety of printed media, such as books, journals, newspapers, and maps. Suppose a user is reading a book titled Introduction to Solid State Physics by Kittel. Setting the index number at 0000, he can scan the page with the author and publisher information. An OCR program can convert the scanned image into a text file. With a little editing, he gets the bibliographic information for the book: Charles Kittel, Introduction to Solid State Physics, 6th ed, John Wiley & Sons, New York, 1986. Now he goes to page 19 and scans the crystal structure of diamond. He can set up the desired scanning area with the slides and the page number with the index number. Once the image file is obtained, the bibliographic information is automatically associated with the image file, and the information is applied to image files related to other notes from the same book. For large documents like maps, several scans can be performed and the image files can be combined by software.

Since most of the scanning operations can be performed without the help of a computer screen, the related software for scanning can be stored and run in a CPU and related memory provided on the portable flatbed scanner.

The digital images can be stored in a compressed format, such as gif format or jpeg format. The digital image data can be transferred into a computer through a USB interface. In addition, the digital images can be stored in removable data storage media, such as those used in digital cameras.

A cover can be provided to protect the surface of the transparent platens from scratching and abrasion. A specifically designed cover is shown in FIG. 4. The portable flatbed scanner 30 is provided with a cover 56. The cover 56 is preferably made of plastics. On the side facing the front of the scanner 30, there is a narrow slot 58 with a width of about 1 mm and a length extending the length of the scanning area of the scanner 30. The slot 58 matches a gap between the cover 56 and the scanner 30. There is also an opening 60 about 20 mm wide and 30 mm long with a corresponding lid 62 hinged on one side of the opening. The slot 58 and opening 60 provide a convenient setup for scanning photographs. A photograph can be inserted from the slot 58 into the scanning area for scanning and the photograph can be taken out by a finger from the opening 60.

1. A portable flatbed scanner comprising:
a first transparent platen facing the original document;
a scanning mechanism movably mounted relative to said first transparent platen;
a second transparent platen at the back of the housing for said scanning mechanism;
whereby the user can see the original document through said first and second transparent platens.

2. The portable flatbed scanner of claim 1, further comprising means for directly setting the scanning area.

3. The portable flatbed scanner of claim 1, wherein said second transparent platen is provided with a grid pattern for alignment of the original document with said scanner.

4. The portable flatbed scanner of claim 1, further comprising a CPU and memory, software for the scanning operation, and data storage media for storing image files;
whereby said portable flatbed scanner can stand alone.

5. The portable flatbed scanner of claim 4, wherein said data storage media is removable.

6. The portable flatbed scanner of claim 1, further comprising a text scan button for starting a scanning process for a text document at predetermined parameters.

7. The portable flatbed scanner of claim 1, further comprising a picture scan button for starting a scanning process for a picture document at predetermined parameters.

8. The portable flatbed scanner of claim 1, further comprising an index number display, a button for increasing said index number, and a button for decreasing said index number, and software for associating the bibliographic information from the image of a predefined index number and the page number from the current index number with a scanned image;
whereby the bibliographic information of an image file is easily available.

9. The portable flatbed scanner of claim 1, further comprising a cover extending to the full length of said transparent platens for protecting said transparent platens.

10. The portable flatbed scanner of claim 9, wherein said cover comprising:
a slot corresponding to a gap between the scanning area of said first transparent platen and said cover;
an opening facing said first transparent platen with a size large enough for a finger;
whereby a document can be inserted from said slot into said gap between said first transparent platen and said cover for scanning, and the document can be removed with a finger from said opening.

11. A method of associating bibliographic information to a scanned image file, comprising:
providing an index number display, a button for increasing said index number, and a button for decreasing said index number;
scanning the bibliographic information of the document for a predefined index number;
setting said index number to the corresponding page number of said document;
scanning said document page to obtain a scanned image file;
associating said bibliographic information of said document and said index number with said scanned image file.
